(19) United States
(12) Patent Application Publication
(10) Pub. No.: US 2019/0031093 A1
(43) Pub. Date: Jan. 31, 2019

(54) APPARATUS AND METHOD OF ILLUMINATING A SPARE TIRE HELD IN A WELL UNDER A FLOORBOARD OF A MOTOR VEHICLE

(71) Applicant: FORD GLOBAL TECHNOLOGIES, LLC, Dearborn, MI (US)

(72) Inventors: Luis Enrique Castillo Jaime, Distrito Federal (MX); Nicole Pamela Herrera Gutierrez, Cuajimalpa (MX); Michelle Carolina Herrera Gutierrez, Cuiajimalpa de Morelos (MX); Scott Holmes Dunham, Redford, MI (US); Stuart C. Salter, White Lake, MI (US)

(21) Appl. No.: 15/659,308

(22) Filed: Jul. 25, 2017

(51) Int. Cl. B60Q 3/30; F21V 19/00; H05B 33/12; B60Q 1/00

(52) U.S. Cl. CPC B60Q 3/30; F21V 19/003; B60Q 2500/00; B60Q 1/0088; H05B 33/12

(57) ABSTRACT

An apparatus for illuminating a spare tire and changing tools held in a well under a floorboard of a motor vehicle includes a light source and an activation switch. The activation switch is configured to turn on the light source when the floorboard is raised to access the spare tire and changing tools in the well. A related method of illuminating a spare tire held in a well under a floorboard of a motor vehicle is also disclosed.

### TECHNICAL FIELD

This document relates generally to the motor vehicle equipment field and, more particularly, to a new and improved apparatus and method for illuminating a spare tire and tools held in a well under a floorboard in a motor vehicle. The illumination enables the operator to easily extract and manipulate the spare tire and tools held in the well under the floorboard especially in presences of unlighted or poorly lit environments.

### BACKGROUND

A motor vehicle is commonly equipped with a spare tire and tools for replacement in case one of the tires is no longer capable of functioning. In most of the vehicles, this equipment is located in the trunk held in a well under a floorboard. When a motor vehicle operator must change a tire in a dark environment, such as a highway at night, a parking lot in the basement of a building, among other places, it is difficult for the operator to retrieve the spare tire and the associated tools. Typically, the design of the trunk light is focused to illuminate only the class A view (that is, the cargo area above the floorboard). Thus, the trunk light is usually located in the upper center zone of the trunk of sedan vehicles where the trunk light allows the customer to see in the inside of the trunk and any luggage or cargo being carried therein.

The spare tire and changing tools for tire replacement are typically located under the trunk floorboard in a well in the super structure of the motor vehicle. In order to access the spare tire and changing tools in this well, the operator must pull or pivot the trunk floorboard upward. In such a situation the floorboard is positioned between the trunk light at the upper center zone of the trunk and the spare tire and changing tools in the well thereby casting a shadow upon the mentioned kit for tire replacement and making them very difficult to see.

While this situation may be addressed by utilizing a flashlight or the light from a cell phone, it should be appreciated that an operator needs free hands to hold the floorboard, to remove the spare tire and changing tools from the trunk and, therefore, cannot effectively also hold and direct such a lighting device. Accordingly, a flashlight or cell phone light is not a good solution to this problem.

This document relates to a new and improved apparatus for illuminating the spare tire as well as the changing tools held in a well under a floorboard of a motor vehicle to thereby allow one to more easily see and access those items when needed. Such an apparatus will improve the user experience while changing a flat tire.

### SUMMARY

In accordance with the purposes and benefits described herein, an apparatus is provided for illuminating a spare tire held in a well under a floorboard. That apparatus comprises a light source and an activation switch configured to activate the light source when the floorboard is raised to access the spare tire in the underlying well. Advantageously, the light source is positioned to provide illumination directly onto the spare tire in the well.

In one possible embodiment, the light source is carried on a trunk rear trim panel, directing illumination motor vehicle forward onto the spare tire when the floorboard is raised to access the spare tire and changing tools.

The activation switch may be a normally opened momentary pushbutton. Such a normally open momentary pushbutton includes a spring-loaded plunger that is engaged by the floorboard when the floorboard is in a home position overlying the spare tire and closing the well.

In some of the many possible embodiments the light source comprises a plurality of light emitting diodes (LEDs). Further, the activation switch may be carried on the motor vehicle beneath the floorboard where it is out of sight and protected from contact and potential damage when loading cargo into the trunk on the trunk floorboard.

Consistent with the above description, a new and improved method is provided of illuminating a spare tire held in a well under a floorboard of a motor vehicle. That method comprises the steps of orienting a light source to direct illumination onto the spare tire and activating the light source by an activation switch configured to be responsive to raising of the floorboard to access the spare tire.

The method may further include the step of mounting the light source on a trim panel of a trunk of the motor vehicle rearward of the well. Further, the method may include the step of using a normally open momentary pushbutton as the activation switch.

In accordance with yet another aspect, a method of illuminating a spare tire held in a well under a floorboard of a motor vehicle comprises the steps of raising the floorboard to access the spare tire in the well and disengaging the floorboard from an activation switch whereby a light source is activated to direct light onto the spare tire.

In the following description, there are shown and described several preferred embodiments of the apparatus and method for illuminating a spare tire held in a well under a floorboard. As it should be realized, the apparatus and method are capable of other, different embodiments and their several details are capable of modification in various, obvious aspects all without departing from the apparatus and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the apparatus and method and together with the description serve to explain certain principles thereof.

FIG. 1 is an electric circuit diagram of the apparatus for illuminating a spare tire held in a well under a floorboard of a motor vehicle.

FIG. 2a is a schematic side section illustration of the floorboard in a home position overlying the spare tire well and engaging the activation switch.

FIG. 2b is a view similar to FIG. 2a but illustrating that floorboard in a raised position, in order to access the spare tire in the spare tire well, so that the floorboard is disengaged from the activation switch.

FIG. 3a is a rear elevational view illustrating a man raising the floorboard and showing the spare tire in the spare tire well formed in the sheet metal super structure under the floorboard.

FIG. 3b is a perspective view illustrating the light source of the apparatus carried on a rear trim panel of the motor vehicle trunk beneath the trunk lid sill with light from the light source being directed motor vehicle forward and downwardly into the spare wheel well onto the spare wheel and changing tools.

Reference will now be made in detail to the present preferred embodiments of the apparatus, examples of which are illustrated in the accompanying drawing figures.

### DETAILED DESCRIPTION

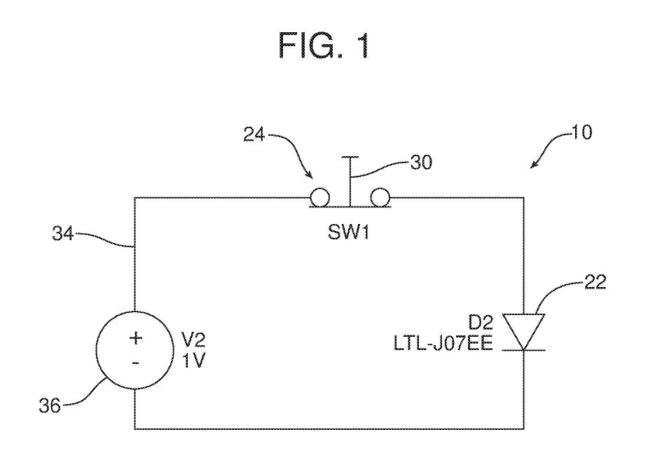

Reference is now made to FIGS. 1-3b illustrating the apparatus 10 for illuminating a spare tire 12 held in a well 14 under a floorboard 16 in the trunk 18 of a motor vehicle 20. As illustrated, the apparatus 10 includes a light source 22 and an activation switch 24.

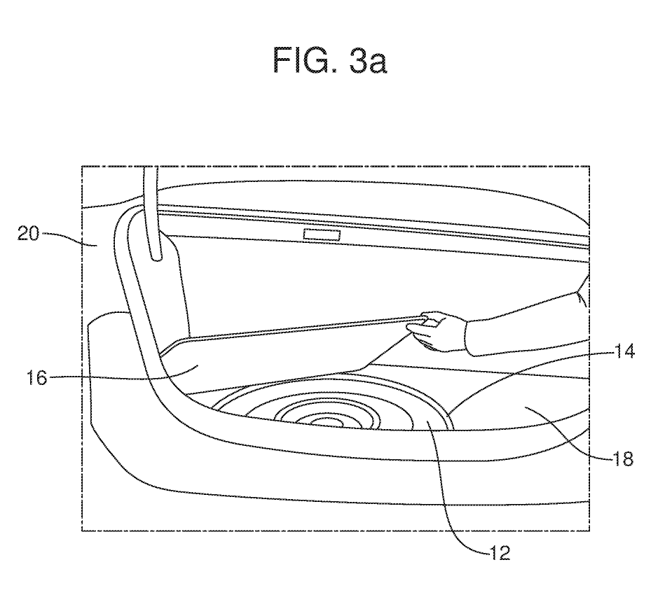

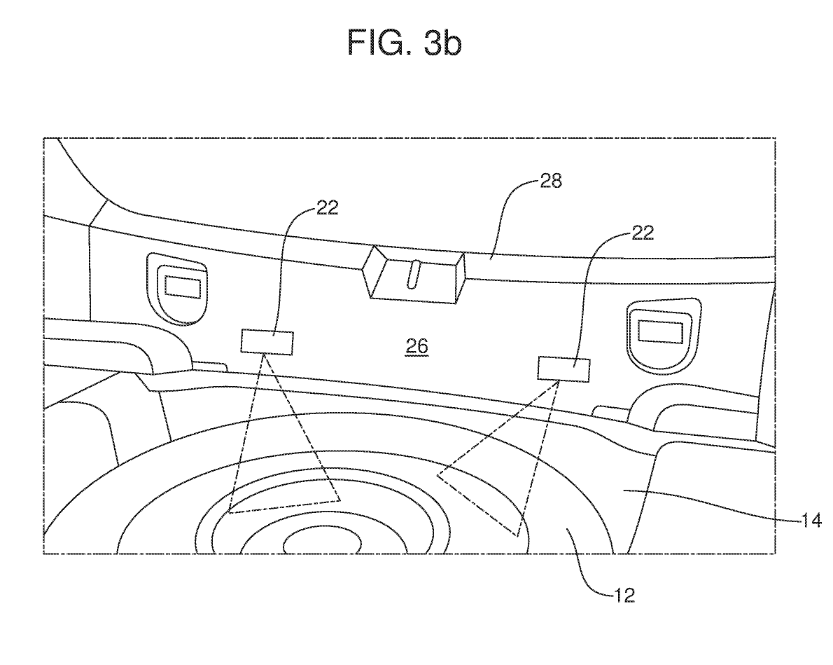

The light source 22 may comprise any suitable light source such as a plurality of light emitting diodes (LEDs). The light source 22 is positioned to direct illumination onto the spare tire 12 in the well 14. Thus, as illustrated in FIG. 3b, the light source 22 may be carried on a trim panel 26 along the rear wall of the motor vehicle trunk 18 beneath the trunk lid sill 28. As illustrated, the light source 22 directs illumination motor vehicle forward and downward onto the spare tire 12 in the well 14 when the floorboard 16 is raised to access the spare tire.

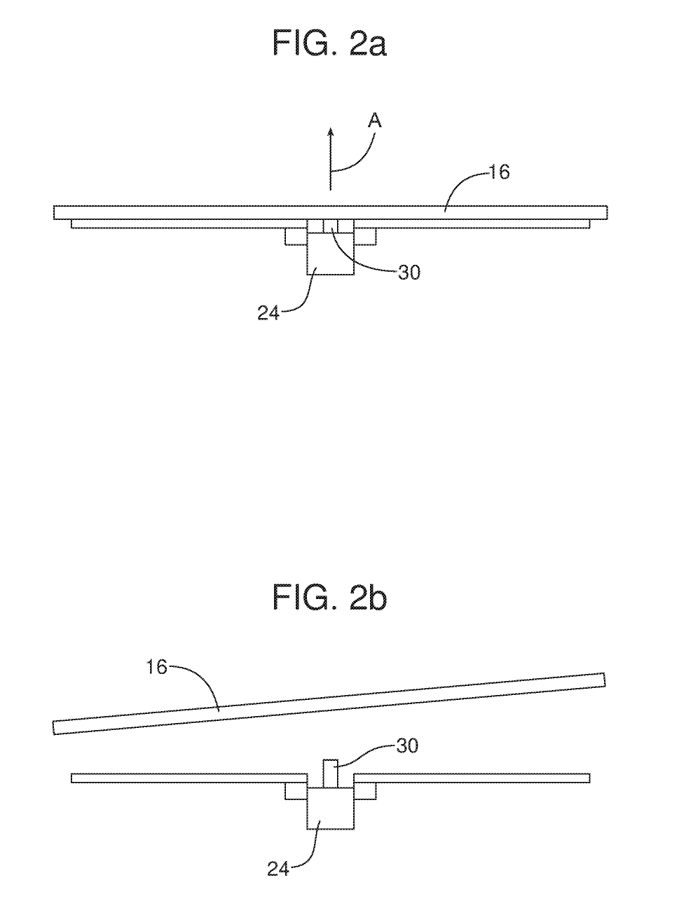

The activation switch 24 may comprise a normally open momentary pushbutton. Such an activation switch is relatively inexpensive yet durable and provide dependable performance over a long service life. Such an activation switch 24 includes a spring-loaded plunger 30 that is engaged by the floorboard 16 when the floorboard is in a home position resting on the sheet metal floor of the trunk overlying the spare tire 12 in the well 14 formed in the sheet metal floor. See particularly FIG. 2a illustrating the floorboard in engagement with and depressing the spring-loaded plunger 30. Since the activation switch 24 is carried on the motor vehicle beneath the floorboard 16, the switch is protected from direct impact with luggage or other articles that are loaded onto the floorboard 16 of the trunk 18 from time to time.

When a vehicle operator wishes to access the spare tire 12, the vehicle operator raises the floorboard 16 in the direction of action arrow A as illustrated in FIG. 2a. This disengages the floorboard 16 from the spring-loaded plunger 30. As a result, the spring-loading biases the plunger 30 upward closing the activation switch 24 and completing the circuit 34 between the motor vehicle power source 36 and the light source 22 (see FIG. 1). In this manner, the light source 22 is activated and light is directed onto the spare tire 12 in the well 14 (see FIG. 3b) thereby allowing the individual to see the spare tire 12 and changing tools and manipulate them in a convenient and efficient manner.

Consistent with the above description, a method is provided of illuminating a spare tire 12 held in a well 14 under a floorboard 16 of a motor vehicle 20. That method may be broadly described as including the steps of: (a) orienting a light source 22 to direct illumination onto the spare tire 12 and (b) activating the light source by an activation switch 24 configured to be responsive to the raising of the floorboard 16 to access the spare tire 12.

The method may also include the step of mounting the light source 22 on a trim panel 26 in a trunk 18 of the motor vehicle 20 rearward of the well 14. FIG. 3b shows the light source 22 provided on that trim panel 26 below the trunk lid sill 28.

In addition, the method may also include the step of using a normally open momentary pushbutton as the activation switch 24.

Stated another way, the method of illuminating a spare tire 12 in a well 14 under a floorboard 16 of a motor vehicle 20 may comprise the steps of: (a) raising the floorboard 16 to access the spare tire 12 in the well 14 and (b) disengaging the floorboard 16 from the activation switch 24 whereby the light source 22 is activated to direct light onto the spare tire 12.

In summary, the apparatus and method described in this document for illuminating a spare tire 12 held in a well 14 under a floorboard 16 in the trunk 18 of a motor vehicle 20 provides a number of benefits and advantages. The apparatus 10 is effectively a dedicated lighting system for the spare tire 12 and any associated changing tools (e.g. lug nut wrench and car jack) held in the well 14 under the floorboard 16. Advantageously, the light source 22 of the apparatus 10 is automatically activated whenever one raises the floorboard 16 in an effort to access the spare tire 12 in the well 14. Advantageously, the light from the light source 22 is directed directly down onto the spare tire in the well 14 allowing an individual to easily see the spare tire and complete the necessary manipulations to remove the spare tire and changing tools from the well in a quick and efficient manner.

As illustrated, the light source 22 may be provided on a trim panel 26 at the rear of the motor vehicle beneath the trunk lid sill 28 so that the light is directed forwardly into the well 14. It should be appreciated that such light is directed away from the individual at the rear of the motor vehicle so as to provide maximum beneficial effect: that is, the individual does not need to look toward or into the light when seeking to access the spare tire and changing tools in the well.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

What is claimed:

1. An apparatus for illuminating a spare tire held in a well under a floorboard, comprising:
a light source; and
an activation switch configured to activate said light source when said floorboard is raised to access said spare tire in said well.

2. The apparatus of claim 1, wherein said light source is positioned to direct illumination onto said spare tire and changing tools in said well.

3. The apparatus of claim 1, wherein said light source is carried on a rear trim panel of a motor vehicle trunk, directing illumination motor vehicle forward onto said spare tire when said floorboard is raised to access said spare tire and changing tools.

4. The apparatus of claim 3, wherein said activation switch is a normally open momentary pushbutton.

5. The apparatus of claim 4, wherein said normally open momentary pushbutton includes a spring-loaded plunger that is engaged by said floorboard when said floorboard is in a home position overlying said spare tire and changing tools, and closing said well.

6. The apparatus of claim 5, wherein said light source comprises a plurality of LEDs.

7. The apparatus of claim 6, wherein said activation switch is carried on a motor vehicle beneath said floorboard.

8. The apparatus of claim 1, wherein said activation switch is a normally open momentary pushbutton.

9. The apparatus of claim 8, wherein said normally open momentary pushbutton includes a spring-loaded plunger that is engaged by said floorboard when said floorboard is in a home position overlying said spare tire and changing tools, and closing said well.

10. The apparatus of claim 9, wherein said light source comprises a plurality of LEDs.

11. The apparatus of claim 10, wherein said activation switch is carried on a motor vehicle beneath said floorboard.

12. A method of illuminating a spare tire held in a well under a floorboard of a motor vehicle, comprising:
orienting a light source to direct illumination onto said spare tire and changing tools; and
activating said light source by an activation switch configured to be responsive to raising of said floorboard to access said spare tire and changing tools.

13. The method of claim 12, including mounting said light source on a rear trim panel of a trunk of a motor vehicle, motor vehicle rearward of said well.

14. The method of claim 13, including using a normally open momentary pushbutton as said activation switch.

15. A method of illuminating a spare tire and changing tools held in a well under a floorboard of a motor vehicle, comprising:
raising said floorboard to access said spare tire and changing tools in said well; and
disengaging said floorboard from an activation switch whereby a light source is activated to direct light onto said spare tire and changing tools.
